(19) United States
(12) Patent Application Publication
(10) Pub. No.: US 2008/0239898 A1
(43) Pub. Date: Oct. 2, 2008

(54) Calibration of Relative Laser Intensities in an Optical Storage System

(75) Inventors: Alexander Marc Van Der Lee, Eindhoven (NL); Christopher Busch, Eindhoven (NL); Dominique Maria Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,268

(22) PCT Filed: Apr. 22, 2005
(86) PCT No.: PCT/IB05/51325

§ 371 Date: Oct. 25, 2006

(30) Foreign Application Priority Data
Apr. 29, 2004 (EP) 04101807.8

(51) Int. Cl. G11B 7/00

(52) U.S. Cl. 369/47.53

(57) ABSTRACT

In conventional one-dimensional optical storage systems, the data is arranged in a linear fashion, and the format is read out by a single spot. A two-dimensional encoded disc is different, because the data is arranged in a two-dimensional manner (bits are on a bit lattice) and the data is read out by multiple spots. It is important to know the relative intensity of the read-out spots, because the intersymbol interference is used in the signal processing of the reflected signals, and the present invention provides a way of calibrating the relative intensities by placing one or more mirror sections (150) in a non user-data area of an optical record carrier (1) and using the signals reflected therefrom to determine the relative intensities and enable the required accurate calibration of the relative intensities. In one exemplary embodiment, a mirror section (15) is located in the lead-in area (2) of the record carrier (1) in addition to a plurality of broad meta-tracks containing calibration patterns (152).

This invention relates to the calibration of relative laser intensities in an optical storage system and, more particularly, to a method and apparatus for calibrating the relative intensity of readout spots in a two-dimensional optical storage system.

Optical data storage systems provide a means for storing large quantities of data on an optical record carrier, such as an optical disc. Storage capacities in digital optical recording systems has increased from 600 MB per disc in CD to 4.7 GB in DVD, and are likely to reach some 25 GB for upcoming systems based on blue laser diodes. Data stored on an optical record carrier is accessed by focusing a laser beam onto the data layer of the disc and then detecting the reflected light beam. In one known system, data is permanently embedded as marks, such as pits, in the disc, and the data is detected as a change in reflectivity as the laser beam passes over the marks.

An optical disc, such as a compact disc (CD) is known as one type of information recording media. According to a standard recording format of the CD, a recording area of the CD comprises a lead-in area, a program area, and a lead-out area. These areas are arranged in that order in a direction from an inner periphery to an outer periphery of the disc. Index information, referred to as the table of contents (TOC) is recorded in the lead-in area. The TOC includes management information as a sub-code which is used for managing information recorded in the program area. For example, if main information recorded in the program area is information relating to a music tune, the management information may comprise the playing time of the tune. Information relating to the track number of the corresponding music tune may also be recorded in the program area. A lead-out code which indicates the end of the program area is recorded in the lead-out area. In some modes, each track may start with a pre-gap of, say, 2 seconds and 150 frames, and in this pre-gap there is no relevant user data.

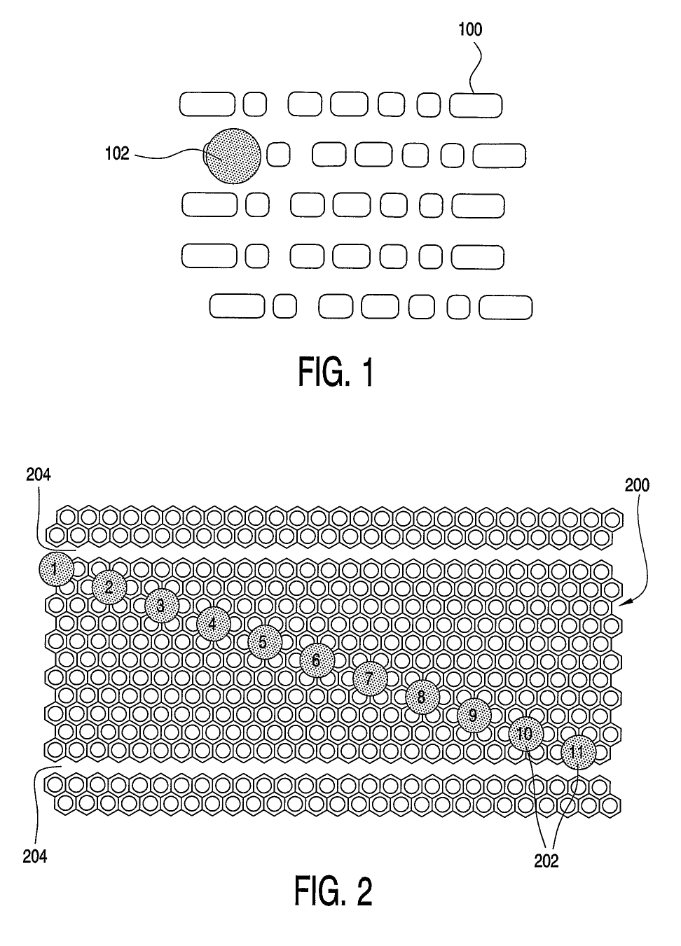

In order to read out or record data, it is necessary to position an optical spot onto the disc track. Referring to FIG. 1 of the drawings, in existing optical systems, data is converted into a serial data stream that is recorded on a single track 100, with ample spacing between adjacent tracks so as to avoid inter-track interference. A single read-out spot 102 is provided and the signal is sampled along the track.

However, the spacing between tracks 100 limits attainable storage capacity, while the serial nature of the data in a one-dimensional optical storage system limits the attainable data throughput. As a result, the concept of two-dimensional optical storage (TwoDOS) has been developed, which is based on innovative two-dimensional channel coding and advanced signal processing, in combination with a read-channel consisting of a multi-spot light path realizing a parallel read-out. TwoDOS is expected to achieve a capacity of at least 50 GB for a 12 cm disc, with a data rate of at least 300 Mb/s.

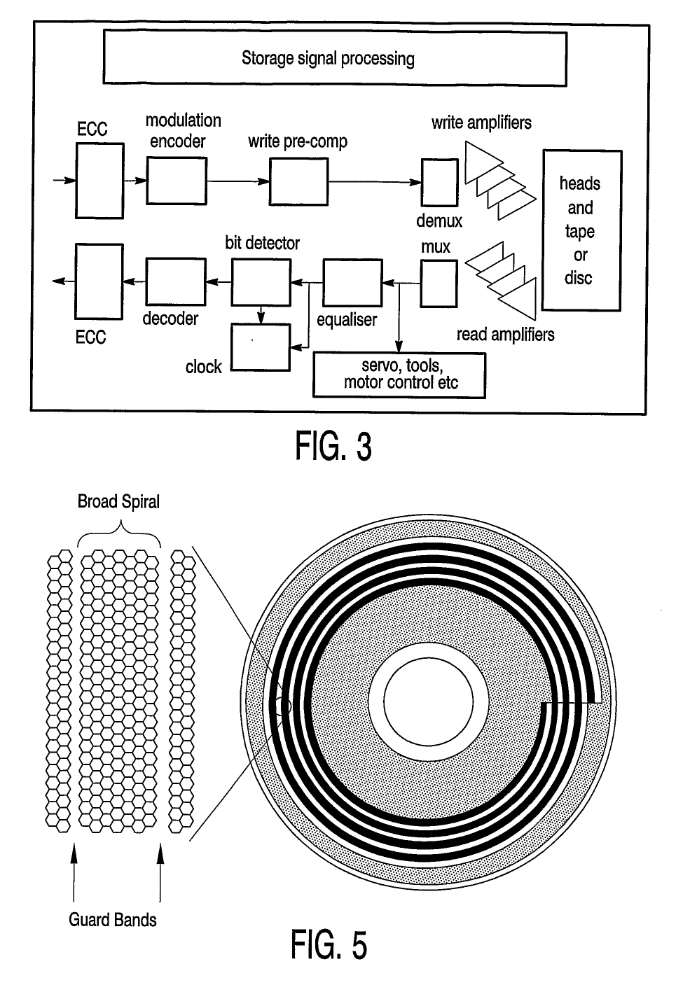

Referring to FIG. 2 of the drawings, in general, the format of a TwoDOS disc is based on a broad spiral, in which the information is recorded in the form of two-dimensional features. Parallel read-out is realized using multiple light spots. These can be generated, for instance, by a single laser beam that passes through a grating and produces an array of laser spots 202. Other options include the use of a laser array or fibre optic arrangement, for example. The information is written in a 2D way, meaning that there is a phase relation between the different bit rows. In FIG. 2, a honeycomb structure 200 is shown, and this can be encoded with a two-dimensional channel code, which facilitates 2D-detection. As shown, the data is contained in a broad meta-track, which consists of several bit rows, wherein the broad meta-track is enclosed by a guard band 204 (i.e. a space containing no data). The array of spots 202 scans the full width of the broad spiral. The light from each laser spot is reflected by the two-dimensional pattern on the disc, and is detected on a photo-detector integrated circuit, which generates a number of high frequency waveforms. The resultant set of signal waveforms is used as the input to a two-dimensional signal processing unit, such as that illustrated schematically in FIG. 3 of the drawings.

The parallelism of the above-described arrangement greatly increases attainable data throughputs and permits individual data tracks to be spaced contiguously with no inter-track spacing, and it will be appreciated that all coding and signal processing operations need to account not only for temporal interaction between neighboring bits (i.e. inter-symbol interference), but also for their spatial (cross-track) spacing. Consequently, the entire recording system becomes fundamentally two-dimensional in nature.

While the multiple spot laser source for a TwoDOS system is designed to provide a predetermined (target) distribution of laser intensities, there will always be deviations from this target distribution due to factors such as manufacturing tolerances, environmental variations and component aging. The same is true for multiple detector element sensitivity and following analogue circuitry, which will also show variations. In order to correctly perform the above-mentioned signal processing in respect of the high frequency waveforms generated by the photo-detector integrated circuit, it is necessary to determine the relative intensities of the readout spots, so that each read-out signal can be attributed a proper weight factor to compensate for the above-mentioned deviation from the target intensity distribution. Setting these relative intensities is necessary because, as explained above, the inter-symbol interference present stemming from adjacent bitrows is then derived from the adjacent read-out spots, the signal of all waveforms is used simultaneously in the signal processing.

It is therefore an object of the present invention to provide a method and apparatus for calibrating the relative intensities of a plurality of optical read-out spots in a multi-dimensional optical storage system. It is also an object of the present invention to provide an optical storage system utilizing such a method or apparatus, an optical record carrier including means for enabling the relative intensities of a plurality of optical read-out spots to be calibrated, and a method of manufacturing such an optical record carrier.

In accordance with the present invention, there is provided an optical record carrier for use in a method of calibrating the relative intensities of a plurality of respective optical read-out spots in a multi-dimensional optical storage system, the optical record carrier comprising one or more mirror sections in a non user-data area thereof.

The present invention extends to a method of manufacturing such an optical record carrier, including providing in a non user-data area thereof one or more mirror sections for use in a method of calibrating the relative intensities of a plurality of respective optical read-out spots in a multi-dimensional optical storage system.

Also in accordance with the present invention, there is provided a method of calibrating the relative intensities of a plurality of respective optical read-out spots in a multi-dimensional optical storage system, the method comprising irradiating an optical record carrier as defined above and performing one or more reflectivity measurements in respect of the one or more mirror sections provided in a non user-data area of said optical record carrier.

The present invention extends further to an optical drive utilizing the method defined above, and comprising means for irradiating an optical record carrier as defined above, means for performing one or more reflectivity measurements in respect of the one or more mirror sections provided in a non user-data area of said optical record carrier, and means for calibrating the relative intensities of the plurality of respective optical read-out spots accordingly.

The aim is calibrating the relative intensities of the optical read-out spots is to normalize the signal to the mirror level. In a preferred embodiment, when the light spot passes a mirror section, the intensity is measured with the photo-detector segment of each spot. This value is then converted by an analogue-to-digital converter (ADC) to a digital value. These resultant mirror values are then used to normalize the data signals for each row respectively, bearing in mind that the assumption is that each spot is independent. The signals of different bit rows should be normalized such that they can be used with a correct weighting in the signal process algorithms such as those referred to above.

In one exemplary embodiment, such mirror sections may be provided in the lead-in area of the optical record carrier. Alternatively, however, a plurality of land cluster sections distributed over the surface of the optical record carrier may be located within the calibration tracks, i.e. the empty bit rows (or guard bands) separating successive user data areas of the optical record carrier. In any event, the mirror sections are beneficially provided substantially at zero-level relative to the surface of the optical record carrier.

In one specific exemplary embodiment, the lead-in area of the optical record carrier may comprise a plurality of bands, at least one of said bands containing calibration patterns and at least another of said bands comprising a mirror section. Alternatively, said bands may be interleaved with mirror sections. Thus, in one embodiment, the lead-in section may comprise a plurality of bands containing calibration patterns, which bands are interleaved with a plurality of mirror sections.

In yet another exemplary embodiment, wherein user data is recorded on the optical record carrier in sections, with guard bands containing no user data being provided between successive user data sections, one or more mirror sections may be provided in one or more of said guard bands. Such mirror sections may comprise clusters of land portions.

These and other aspects of the present invention will be apparent from, and elucidated with reference to, the embodiments described herein.

Embodiments of the present invention will now be described by way of examples only, and with reference to the accompanying drawings, in which:

FIG. 1 is a schematic illustration of data storage in a one-dimensional optical storage arrangement;

FIG. 2 is a schematic illustration of data storage in a two-dimensional optical storage arrangement;

FIG. 3 is a schematic block diagram of a signal processing unit suitable for use in a two-dimensional optical storage arrangement;

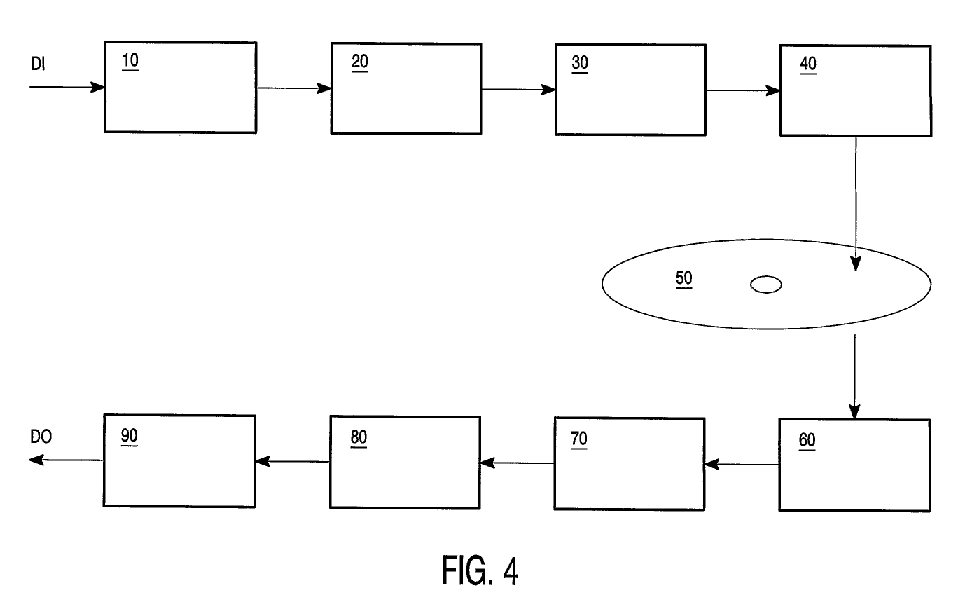

FIG. 4 is a schematic block diagram illustrating typical coding and signal processing elements of a data storage system;

FIG. 5 is a schematic illustration of the manner in which data is recorded in a two-dimensional optical storage system;

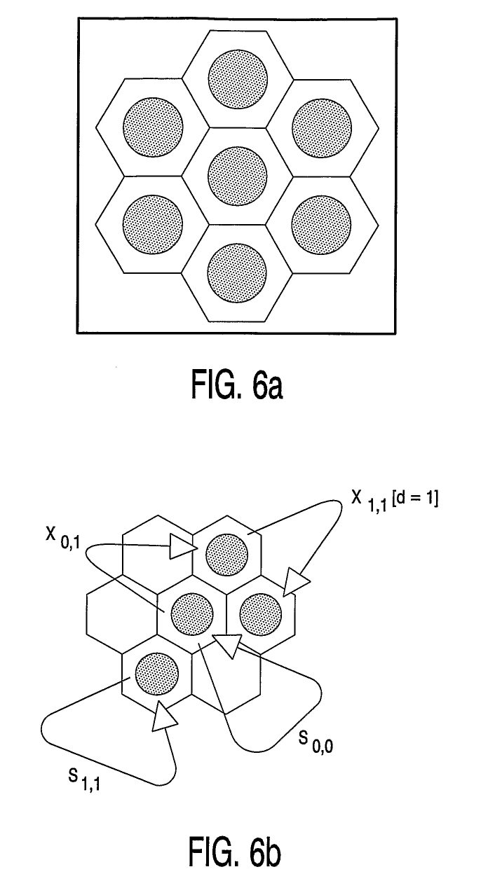

FIG. 6a is a schematic representation of the hexagonal structure and the corresponding bits in a two-dimensional encoded optical record carrier;

FIG. 6b is a schematic representation illustrating two types of bilinear interference of wavefronts on a seven-bit hexagonal cluster in a two-dimensional encoded optical record carrier;

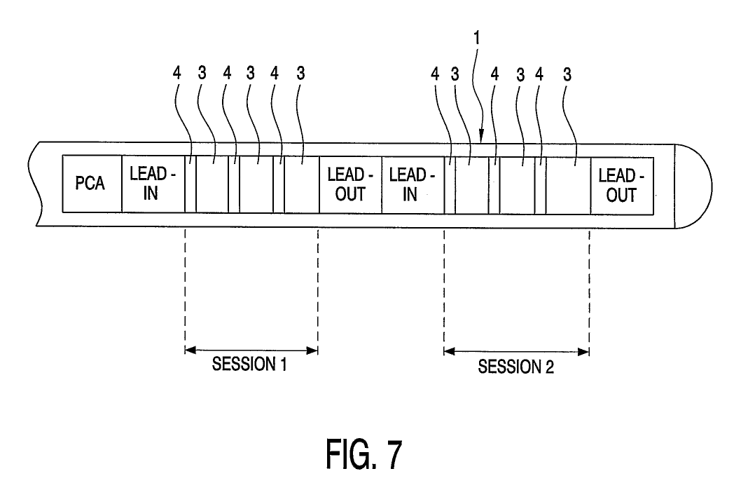

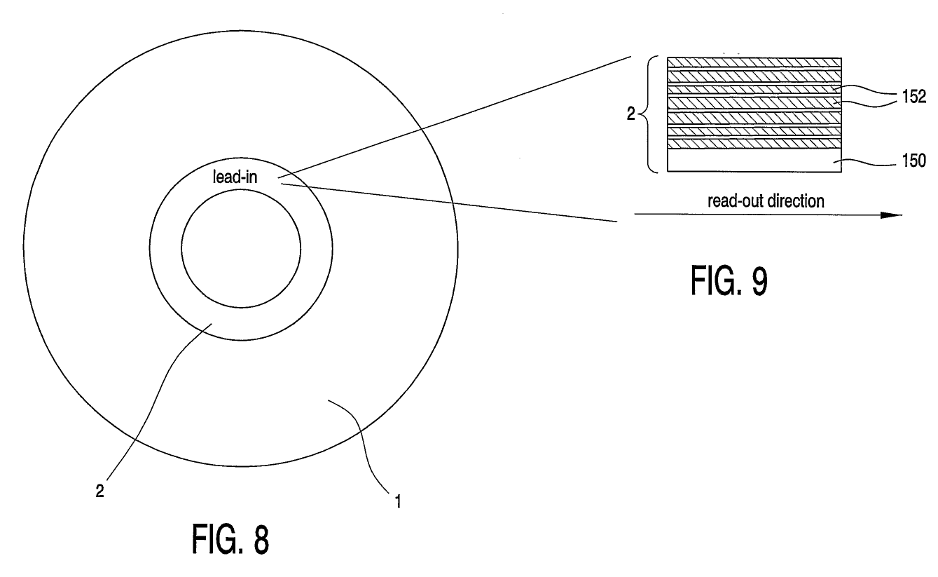

FIGS. 7 and 8 are schematic cross-sectional and plan views respectively illustrating the layout of user-data and non user-data areas of an optical record carrier;

FIG. 9 is a schematic illustration of the lead-in area of an optical record carrier according to a first exemplary embodiment of the present invention;

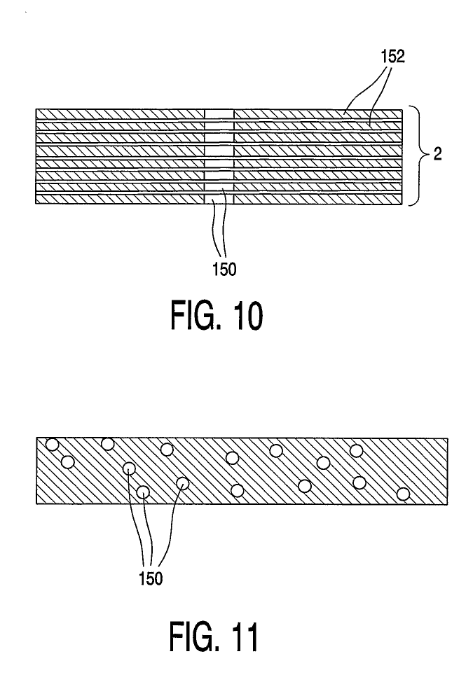

FIG. 10 is a schematic illustration of the lead-in area of an optical record carrier according to a second exemplary embodiment of the present invention; and

FIG. 11 is a schematic illustration of the lead-in area of an optical record carrier according to a third exemplary embodiment of the present invention.

Thus, a new concept for two-dimensional optical storage is being developed in which the information on the disc fundamentally has a two-dimensional character. The aim is to achieve an increase over the third generation of optical storage (Blu-ray Disc (BD) with wavelength λ=405 nm and a NA of 0.85) by a factor of 2 in data density and by a factor of 10 in data rate (for the same physical parameters of the optical readout system).

FIG. 4 shows typical coding and signal processing elements of a data storage system. The cycle of user data from input DI to output DO can include interleaving 10, error-correction-code (ECC) and modulation encoding 20, 30, signal preprocessing 40, data storage on the recording medium 50, signal pick-up and post-processing 60, binary detection 70, and decoding 80, 90 of the interleaved ECC. The ECC encoder 20 adds redundancy to the data in order to provide protection from various noise sources. The ECC-encoded data are then passed on to a modulation encoder 30 which adapts the data to the channel, i.e. it manipulates the data into a form less likely to be corrupted by channel errors and more easily detected at the channel output. The modulated data, i.e. the channel bits, are then input to a writing or mastering device, e.g. a spatial light or electron beam modulator or the like, and stored on the recording medium 50, e.g. optical disc or card. On the receiving side, a reading device or pick-up unit comprising, for example, a partitioned photo-detector, or an array of detectors, which may be one-dimensional or even two-dimensional as in the charge coupled device (CCD), converts the received radiation pattern reflected from the recording medium 50 into pseudo-analog data values which must be transformed back into digital data (typically one bit per pixel for binary modulation, but log₂(M) bits per pixel for multi-level, or M-ary, modulation). Thus, the first step in this reading process is a detection and post-processing step 60 comprising an equalization step which attempts to undo distortions created in the recording process. The equalization step can be carried out in the pseudo-analog domain. Then the array of pseudo-analog values is converted to an array of binary digital data via a detector 70. The array of digital data is then passed first to the modulation decoder 80, which performs the inverse operation to modulation encoding, and then to an ECC decoder.

As explained above, in this new concept of two-dimensional optical storage, the bits are organized in a broad spiral. Such a spiral consists of a number of bit rows stacked one upon another with a fixed phase relation in the radial direction, such that the bits are arranged on a two-dimensional lattice. A two-dimensional closed-packed hexagonal ordering of the bits is chosen because it has a 15% higher packing fraction than the square lattice.

Successive revolutions of the broad spiral are separated by a guard band consisting of one empty bit row, as shown in FIG. 5 of the drawings. A multi-spot light path for parallel readout is realized, where each spot has BD characteristics. Signal processing with equalization, timing recovery and bit detection is carried out in a two-dimensional fashion, i.e. jointly over all the bit rows within the broad spiral, as explained above.

Interpixel or intersymbol interference (ISI) is a phenomenon in which the signal waveform at one particular pixel is contaminated by data at nearby pixels. Physically, this arises from the band-limit of the (optical) channel, originating from optical diffraction, or from time-varying aberrations in the optical pick-up system, like disc tilt and defocus of the laser beam.

Furthermore, a characteristic feature of two-dimensional optical storage is that the distance of a bit to its nearest neighboring bits is identical for all (tangential and radial) directions. As a result, a problem known as “signal folding” may arise when the pit mark for a pit bit is assumed to cover the complete hexagonal bit cell. For a large contiguous pit area, consisting of a number of neighboring pit bits, there is no diffraction at all. Consequently, a large pit area and a large non-pit (or “land”) area will show identical readout signals because they both act as perfect mirrors. In other words, the reflection signals from a large land portion, i.e. a mirror portion at zero-level (relative to the surface of the optical record carrier), and from a large pit portion, i.e. mirror portion below zero-level (e.g. at a depth of around or equal to λ/4, where λ denotes the wavelength of the radiation used for reading, adapted for the index of refraction n of the material used for the substrate layer of the disc), are completely identical. As a result, the channel becomes highly non-linear, and a non-linear signal processing model for scalar diffraction has been developed in which the signal levels for all possible hexagonal clusters are calculated (see M. J. Coene, Nonlinear Signal-Processing Model for Scalar Diffraction in Optical Recording, Nov. 10, 2003, Vol. 42, No. 32, APPLIED OPTICS):

$$I = 1 - {\sum }_{i} {c}_{i} {b}_{i} - 2 {\sum }_{i < j} {d}_{i , j} {b}_{i} {b}_{j}$$

where bᵢ is the bit value (0 or 1) indicating the presence of a pithole at site I, cᵢ are the linear coefficients, and dᵢⱼ are the nonlinear coefficients describing the signal response of the bit pattern on the disc.

It will be appreciated that normalization of the signals, i.e. determining the signal level which is equal to 1, is the signal level for mirror sections/clusters containing no pit marks (as explained in more detail later).

The above-mentioned signal processing model yields linear and bilinear terms. Among the bilinear terms, there are self-interference terms for each bit pit (close enough to the centre that the bit is within the area of the illuminating spot), and cross-interference terms for each bit pair (with both pit bits within the area of the illuminating spot). Thus, referring to FIG. 6a of the drawings, a schematic representation is provided of the hexagonal structure and the corresponding bits. For the signal reconstruction, the bits close to the central bit are important. In the illustration, the nearest neighbors are shown. The central bit is labelled b₀ and the surrounding bits are labelled b₁ to b₆. With the help of the above-mentioned equation, the electric field on the disc can be reconstructed. Referring to FIG. 6b of the drawings, two types of bilinear interference of wavefronts on the seven-bit hexagonal cluster are illustrated: self-interference s_{0,0} and s_{1,1} and cross-interference x_{0,1} and x_{1,1}.

As explained above, while the multiple spot laser source for a TwoDOS system is designed to provide a predetermined (target) distribution of laser intensities, there will always be deviations from this target distribution due to factors such as manufacturing tolerances, environmental variations and component aging. The same is true for multiple detector element sensitivity and following analogue circuitry, which will also show variations. In order to correctly perform the above-described signal processing in respect of the high frequency waveforms generated by the photo-detector integrated circuit, it is necessary to determine the relative intensities of the readout spots, so that each read-out signal can be attributed a proper weight factor to compensate for the above-mentioned deviation from the target intensity distribution. Setting these relative intensities is necessary because, as explained above, the inter-symbol interference present in the derived from adjacent read-out spots is used in the signal processing, and it is an object of the invention to provide a way of calibrating the relative intensities of a plurality of optical read-out spots in a multi-dimensional optical storage system.

As explained above, the aim is calibrating the relative intensities of the optical read-out spots is to normalize the signal to the mirror level. In a preferred embodiment, when the light spot passes a mirror section, the intensity is measured with the photo-detector segment of each spot. This value is then converted by an analogue-to-digital converter (ADC) to a digital value. These resultant mirror values are then used to normalize the data signals for each row respectively, bearing in mind that the assumption is that each spot is independent. The signals of different bit rows should be normalized such that they can be used with a correct weighting in the signal process algorithms such as those referred to above.

According to a standard recording format, a recording area of an optical record carrier comprises a lead-in area, a program area, and a lead-out area, as illustrated schematically in FIGS. 7 and 8 of the drawings. These areas are arranged in that order in a direction from an inner periphery to an outer periphery of the disc 1. Index information, referred to as the table of contents (TOC) is recorded in the lead-in area. The TOC includes management information as a sub-code which is used for managing information recorded in the program area. A power calibration area (PCA) is also provided to facilitate the performance of optimum power control (OPC). In at least some modes, each track 3 recorded on the disc starts with a pre-gap 4 of, say, 2 seconds and 150 frames, and in this pre-gap 4 there is no relevant user data.

In accordance with an exemplary embodiment of the invention, the above-mentioned object is achieved, by providing one or more mirror sections in the lead-in area of an optical record carrier, such as a disc or card.

Referring to FIG. 9 of the drawings, in a first exemplary embodiment of the invention, the lead-in area 2 of the optical record carrier is provided with a band 150 which contains no data, i.e. a mirror surface. The remaining portion of the lead-in area 2 may be provided with all sorts of calibration patterns 152, as will be apparent to a person skilled in the art. The band 50 should have a width corresponding to the tolerable eccentricity of the record carrier (say 30 micrometers) such that the readout spots remain on the mirror section 150 during a revolution (since no active radial tracking is possible). The mirror section 150 is therefore completely separated from the rest of the calibration patterns 152. During one revolution of the optical disc 1, the reflectivity of the disc can change. It is therefore important to use the local reflectivity of the disc 1 to determine the relative detected intensity distribution of the spot array and average the relative distribution (if desired) over larger disc segments.

The advantage of this method is that it is relatively straightforward, although a disadvantage is that it takes up quite some space in the lead-in area of the disc (equivalent to roughly 20 broad meta tracks).

Referring to FIG. 10 of the drawings, in another exemplary embodiment, the calibration patterns 152 provided in the lead-in 2 of the optical record carrier 1 may be interleaved with mirror sections 150. At least at some time, the readout spots will fall on the mirror sections 152 and enable the determination of the required information relating to the relative intensities. This implementation is relatively cost-effective in terms of disc area, although a slightly more elaborate algorithm is required to separate the data: obtained from the calibration patterns 152 and that obtained from the mirror sections 150.

Referring to FIG. 11 of the drawings, in yet another exemplary embodiment of the present invention, a plurality of land cluster sections (i.e. mirror sections at zero-level) are provided within the calibration tracks or pre-gaps 4 of the optical record carrier. Thus, in this case, each cluster should comprise a central bit (at least first shell and possibly more shells empty) and surrounding bits which are land sections, i.e. no pit-holes. The signal values when the readout spots are on an all-land cluster are collected and from these the relative intensities are derived.

This method is even more cost-effective than the other two exemplary embodiments, but the measurements are more distributed over the disc surface so they are more sensitive to disc variations.

In all cases, an array of readout spots may be imaged onto the disc surface by an objective lens, and the spots may then be imaged on a partitioned photo detector, that measures the central aperture (CA) signal of each spot. In order to calibrate the intensity of each spot, it is proposed to provide one or more mirror sections in a non-user area of the disc, such as the lead-in area or the pre-gaps (calibration bit rows). It is advantageous to use signal patterns obtained by reflection from such mirror sections because there is no influence from media noise and no influence due to possible pit size or pattern variations. Furthermore, the invention provides the ability for automatic calibration to the maximum signal intensity and the levels obtained from the signal received from the mirror section(s) can also be used to adjust the gain of the detector amplifiers or the laser power so as to achieve optimal use of the dynamic range of the A/D converters and to prevent non-linearities in the analog detection circuit.

It would not be an acceptable alternative to simply use the statistical occurrence of either mirror (land) clusters or identical clusters for calibration purposes since the variations caused by, for example, metal layer thickness variations require that the calibration measurement is restricted to a small local area.

Thus, in summary, in conventional one-dimensional optical storage systems, the data is arranged in a linear fashion, and the format is read out by a single spot. A two-dimensional encoded disc is different, because the data is arranged in a two-dimensional manner (bits are on a bit lattice) and the data is read out by multiple spots. It is important to know the relative intensity of the read-out spots, for the reasons given above, and the present invention provides a way of calibrating the relative intensities by placing one or more mirror sections in a non user-data area of an optical record carrier and using the signals reflected therefrom to determine the relative intensities and enable the required accurate calibration of the relative intensities.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An optical record carrier (1) for use in a method of calibrating the relative intensities of a plurality of respective optical read-out spots (202) in a multi-dimensional optical storage system, the optical record carrier (1) comprising one or more mirror sections (15) in a non user-data area (204,2) thereof.

2. An optical record carrier (1) according to claim 1, wherein said one or more mirror sections (15) are provided in the lead-in area (2) of the optical carrier (1).

3. An optical record carrier (1) according to claim 1, wherein a plurality of land cluster sections (150) distributed over the surface of the optical record carrier (1) are located within the calibration tracks (204) separating successive user data areas of the optical record carrier (1).

4. An optical record carrier (1) according to claim 1, wherein the one or more mirror sections (150) are provided substantially at zero-level relative to the surface of the optical record carrier (1).

5. An optical record carrier (1) according to claim 2, wherein the lead-in area (2) of the optical record carrier (1) comprises a plurality of bands, at least one of said bands (152) containing calibration patterns and at least another of said bands (150) comprising a mirror section.

6. An optical record carrier (1) according to claim 2, wherein said lead in area (2) of said optical record carrier (1) comprises a plurality of bands, at least one of said bands (152) containing calibration patterns, said bands (152) being interleaved with mirror sections (150).

7. An optical record carrier (1) according to claim 3, wherein user data is recorded on the optical record carrier (1) in sections, with guard bands (204) containing no user data being provided between successive user data sections, one or more mirror sections (150) may be provided in one or more of said guard bands (204).

8. An optical record carrier (1) according to claim 7, wherein said mirror sections (150) comprise clusters of land portions.

9. A method of manufacturing an optical record carrier (1) according to claim 1, the method including providing in a non user-data area thereof one or more mirror sections (150) for use in a method of calibrating the relative intensities of a plurality of respective optical read-out spots (202) in a multi-dimensional optical storage system.

10. A method of calibrating the relative intensities of a plurality of respective optical read-out spots (202) in a multi-dimensional optical storage system, the method comprising irradiating an optical record carrier (1) according to claim 1, and performing one or more reflectivity measurements in respect of the one or more mirror sections (150) provided in a non user-data area of said optical record carrier (1).

11. An optical drive utilizing the method of claim 10, and comprising means for irradiating an optical record carrier (1) for use in a method of calibrating the relative intensities of a plurality of respective optical read-out spots (202) in a multi-dimensional optical storage system, the optical record carrier (1) comprising one or more mirror sections (15) in a non user-data area (204,2) thereof, means for performing one or more reflectivity measurements in respect of the one or more mirror sections (150) provided in a non user-data area of said optical record carrier (1) and means for calibrating the relative intensities of the plurality of respective optical read-out spots (202) accordingly.
